(19) United States
(12) Patent Application Publication
(10) Pub. No.: US 2015/0025882 A1
(43) Pub. Date: Jan. 22, 2015

(54) METHOD FOR OPERATING CONVERSATION SERVICE BASED ON MESSENGER, USER INTERFACE AND ELECTRONIC DEVICE USING THE SAME

(71) Applicant: Samsung Electronics Co., Ltd., Suwon-si (KR)

(72) Inventor: Sangwook PARK, Seoul (KR)

(21) Appl. No.: 14/332,766

(22) Filed: Jul. 16, 2014

(30) Foreign Application Priority Data
Jul. 16, 2013 (KR) 10-2013-0083331

(51) Int. Cl. H04L 29/06; G10L 15/26; H04L 12/58; G06F 3/0484; G06F 3/0482

(52) U.S. Cl. CPC H04L 65/403; G06F 3/04842; G06F 3/0482; H04L 51/046; G10L 15/26
USPC 704/235; 715/752

(57) ABSTRACT

A method and a terminal for operating a conversation service function based on a messenger are provided. The terminal includes a radio frequency communication unit configured to support transmission and reception of conversation information including at least one of text data, still image data, video image data, and voice data during an operation of a conversation function based on the messenger, a display unit configured to display a conversation function screen according to an operation of the conversation function based on the messenger, and a controller configured to output a text message based on the conversation information, and to output a thumbnail image corresponding to one of the received still image data and the received video image data on a user designation profile image region, when the still image data and the video image data are received during the operation of the conversation function based on the messenger.

### CROSS-REFERENCE TO RELATED APPLICATION(S)

This application claims the benefit under 35 U.S.C. §119(a) of a Korean patent application filed on Jul. 16, 2013 in the Korean Intellectual Property Office and assigned Serial number 10-2013-0083331, the entire disclosure of which is hereby incorporated by reference.

### TECHNICAL FIELD

The present disclosure relates to a method of operating a conversation service, a user interface and an electronic device supporting the same. More particularly, the present disclosure relates to a method for operating a conversation service based on a messenger, a user interface and an electronic device supporting the same.

### BACKGROUND

Currently, as a communication technology has developed, an electronic device, for example, a portable terminal such as a smart phone, a tablet PC, and the like has been widely used. Such a portable terminal has been used in various fields due to ease of use and easy portability. Currently, various functions of the portable terminal are newly applied in addition to a sound, a call, and an SMS. Further, the portable terminal has also been developed in view of size, design, and user interface requirements of a user.

With the development of various communication networks, utilization of a messenger service capable of transferring information between terminals in real time is rapidly increasing. The messenger service is a service to provide information such as chatting between multi-users, transmission of photographs and moving image files using a data network. Messenger subscribers access a messenger server through the data network, and the messenger server may support a medium function to transfer a conversation between subscribers by connecting the subscribers to each other. Such a messenger service may provide transmission message contents and reception message contents on the same screen in an instant method.

Currently, an instant messenger service may support a voice function and an image function as well as a character conversation function. Since a size of a display unit is restrictive in a portable terminal, it is not so easy to efficiently operate the character conversation function and the sound and image function. For example, users may desire implementation of a real time image chatting while exchanging characters through a character conversation screen based on a messenger. In this case, in order to implement the real time image chatting, a terminal may execute another application to support the real time image chatting, or change a screen for outputting a user image and an image of other user on a conversation function screen into a full screen to provide the full screen.

That is, if an activation request of an image service function is detected while using a character conversation service, the image of other user and the user image may be changed into the full screen while a camera is turned-on. Accordingly, the terminal may not simultaneously provide the user image and the character conversation screen.

Accordingly, a method for operating a conversation service function capable of providing voice data and video data of a user in an instant method by using a character conversation function screen based on a messenger and a user device supporting the same is desired.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for operating a conversation service function capable of providing voice data and video data of a user in an instant method by using a character conversation function screen based on a messenger and a user device supporting the same.

The present disclosure further may provide a method for operating a conversation service function based on a messenger capable of efficiently displaying video and voice conversation information of the user as well as voice conversation, and enabling a user to conveniently use corresponding information by recording video and voice data of the user on a character conversation function screen based on a messenger and providing the recorded video and voice data together with characters, that is, text data in an instant method, a user interface and a user device supporting the same.

In accordance with an aspect of the present disclosure, a method for operating a conversation service function based on a messenger is provided. The method includes detecting an input of a user requesting a change of a conversation mode during an operation of the conversation service function, activating a camera according to the change of the conversation mode, collecting user image data from the activated camera, and transmitting the collected user image data and a text message generated according to the input of the user to a terminal

In accordance with another aspect of the present disclosure, a method for operating a conversation service function based on a messenger is provided. The method includes receiving conversation information including at least one of text data, still image data, video image data, and voice data during an operation of the conversation service function, and displaying a conversation function screen to output a text message based on the received conversation information and to output a thumbnail image corresponding to one of the received still image data and the received video image data on a user designation profile image region.

In accordance with another aspect of the present disclosure, a terminal for supporting a conversation service function based on a messenger is provided. The terminal includes a radio frequency communication unit configured to support transmission and reception of conversation information including at least one of text data, still image data, video image data, and voice data during an operation of a conversation function based on the messenger, a display unit configured to display a conversation function screen according to an operation of the conversation function based on the messenger, and a controller configured to output a text message based on the conversation information, and to output a thumbnail image corresponding to one of the received still image data and the received video image data on a user designation profile image region, when the still image data and the video image data are received during the operation of the conversation function based on the messenger.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description in conjunction with the accompanying drawings, in which:

FIG. 1 is a block diagram illustrating a configuration of a user device to support operation of a conversation service based on a messenger according to an embodiment of the present disclosure;

FIG. 2 is a flowchart illustrating a method for operating a conversation service function based on a messenger according to an embodiment of the present disclosure;

FIG. 3 is a diagram of a user interface screen for illustrating a conversation mode change screen based on a messenger according to an embodiment of the present disclosure;

FIGS. 4A and 4B are diagrams of a user interface screen for operating a conversation service function based on a messenger according to an embodiment of the present disclosure; and

FIGS. 5A and 5B are diagrams of a user interface screen for operating a conversation service function based on a messenger according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A method and an apparatus according to the present disclosure are applicable to a portable terminal. It will be apparent that such a portable terminal is a mobile phone, a smart phone, a tablet Personal Computer (PC), a hand-held PC, a Portable Multimedia Player (PMP), a Personal Digital Assistant (PDA), and the like.

In a following description, it is assumed that a method and apparatus for operating a conversation message menu of an electronic device according to the present disclosure are applied to a portable terminal

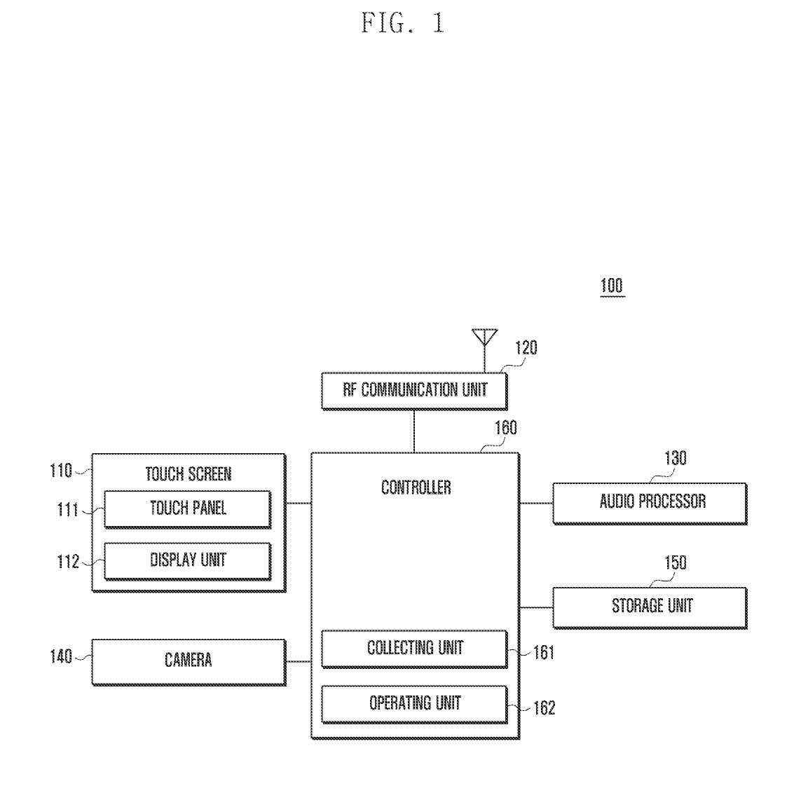

FIG. 1 is a block diagram illustrating a configuration of a user device to support operation of a conversation service based on a messenger according to an embodiment of the present disclosure.

Referring to FIG. 1, a terminal 100 according to the present disclosure may include a touch screen 110, a Radio Frequency (RF) communication unit 120, an audio processor 130, a camera 140, a storage unit 150, and a controller 160, but is not limited thereto. The touch screen 110 may include a touch panel 111 and a display unit 112.

If at least one conversation information among texts, video and audio data is collected according to operation of a conversation service function based on a messenger, the terminal of the present disclosure having a configuration as described above may transmit the collected data to a terminal of other user in an instant method. The terminal 100 may support an effect to provide an image of a user in real time when operating a conversation service function by arranging a user image (video data and/or audio data) to be output on a user designation image region of a conversation function screen in a thumbnail format. In addition, when a playing request for a user image provided in an instant method is detected, the terminal 100 may support a function of simultaneously a character conversation function screen based on a text and a user image by providing a screen of displaying a corresponding user image on a certain region of a conversation function screen.

The touch screen 110 may display a screen according to execution of a user function, and may detect a touch event related with control of the user function. The display unit 112 may convert image data input from the controller 160 into an analog signal to display the analog signal under control of the controller 160. That is, the display unit 112 may provide various screens, for example, a lock screen, a home screen, an Application (hereinafter, referred to as ‘APP’) execution screen, a menu screen, a keypad screen, a message writing screen, and an Internet screen according to utilization of a portable terminal.

The display unit 112 of the present disclosure may output various screens according to an operation of the conversation service function. For example, the display unit 112 may output a screen for creating conversation information during an operation of a conversation service function based on a messenger, a screen transmitting created conversation information, a conversation information receiving screen, a conversation mode change screen, a screen to output video data to a user designation image region, a screen to support division of a screen into a play screen of video data and a conversation function screen, and a conversation partner list screen.

The touch panel 111 may generate and convert an analog signal (e.g., touch event) into a digital signal in response to user input information (e.g., user gesture) for the touch panel 111 to transfer the digital signal to the controller 160. In this case, the touch event may include touch coordinate (X, Y) information. When the touch event is received from the touch screen 110, the controller 160 may determine that a touch means (e.g., finger or pen) touches the touch screen. When the touch event is not received from the touch screen 110, the controller 160 may determine that touch is released. Further, when a touch coordinate is changed, the controller 160 may determine that the touch is moved, and calculate a location variation amount and moving speed of the touch in response to movement of the touch. The controller 160 may support a function to distinguish a user gesture based on the touch coordinate, the release of the touch, the movement of the touch, the location variation amount of the touch, and the moving speed of the touch.

The touch panel 111 may generate a touch event based on various input signals necessary for the operation of the conversation service function. For example, the touch panel 111 may generate a touch event according to an input signal for selecting and activating a conversation function application based on a messenger, an input signal for changing a conversation mode, an input signal for creating conversation information based on a text, an input signal for transmitting the created conversation information, and an input signal for confirming received conversation information to transfer the generated touch event to the controller 160.

The RF communication unit 120 may perform communication of the terminal 100. The RF communication unit 120 may perform communication such as voice communication, image communication, and data communication by forming a communication channel with a supportable mobile communication network under control of the controller 160. The RF communication unit 120 may include an RF transmitter for up-converting a frequency of a transmitted signal and amplifying the signal, and an RF receiver for low-noise-amplifying a received signal and down-converting a frequency of the signal.

The RF communication unit 120 may support formation of a messenger service channel for an operation of the conversation service function of the present disclosure. In this case, the messenger service channel may be a service channel for various types of message transmission and reception such as a short message, a multimedia message, and an instant message. The RF communication unit 120 may support transmission and reception of text, audio and video data during the operation of the conversation service function. Here, the RF communication unit 120 may use at least one other terminal address information designated by the user in order to operate a conversation service function. The other terminal address information may be previously registered and managed or registered and managed according to a new request and an approval of the user.

The audio processor 130 Digital-to-Analog (DA) converts audio data such as a voice input from the controller 160 to transmit the analog audio data to a speaker SPK. The audio processor 130 Analog-to-Digital (AD) converts the audio data such as a voice input from a microphone MIC to transfer the digital audio data to the controller 160. The audio processor 130 may include a Coder/Decoder (CODEC). The CODEC may include a data CODEC to process packet data and an audio CODEC to process an audio signal such as a voice. The audio processor 130 may convert a received digital audio signal into an analog signal through the audio CODEC to play the converted analog signal through the speaker. The audio processor 130 may convert an analog audio signal input from the microphone into a digital audio signal through the audio CODEC to transfer the converted digital audio signal to the controller 160.

A camera 140 may provide a collected image through photographing. The camera 140 may include a camera sensor, an image signal processor, and a digital signal processor. The camera sensor may convert an input optical signal into an electric signal. The image signal processor may convert an analog image signal photographed from the camera sensor into digital data. The digital signal processor may process (e.g., scaling, noise removal, RCG signal conversion) a video signal in order to display digital data output from the image signal processor on the display unit 112. In the present disclosure, although the camera 140 may be disposed at a front surface and a rear surface of the terminal respectively, the camera 140 activated during an operation of a conversation function based on a messenger may be a front camera disposed at the front surface of the terminal, but not limited thereto.

The storage unit 150 may store various data generated in the terminal 100 as well as an Operating System (OS) and various applications of the terminal 100. The data may include data generated when the application of the terminal 100 is executed, and all types of data which may be generated by using the terminal 100 or may be received from the exterior (e.g., an external server, other portable terminal, and a personal computer) and be stored. The storage unit 150 may store user interface provided from a portable terminal and various information for the processing of functions of the portable terminal

The storage unit 150 may include a conversation function application based on a messenger, a conversation partner list, and conversation information data. The conversation function application may be activated by selection of the user or setting of the terminal, may output conversation information or a screen for creating the conversation information after the conversation function application is activated. Further, when video data is received, the conversation function application may output video data on the user designation image region of the conversation function screen in a thumbnail format. Whenever video data is received, the conversation function application may differently output the user designation image region in response to the received video data. In addition, the conversation function application may output an indicator icon or a play icon indicating that the video data is received on a conversation function screen. If a signal for requesting a play of the video data is detected, the conversation function application may divide and output a conversation function screen based on a text and a play screen of the video data.

The controller 160 may control an overall operation of the terminal 100 and signal flow between internal configurations of the terminal 100, and execute a function processing data. Further, the controller 170 may control power supply from a battery to internal constituent elements. If power is supplied to the controller 160, the controller 160 may control a booting procedure of the terminal 100, and may execute various application programs stored in a program area in order to execute a function of the terminal 100 according to user setting.

The controller 160 according to the present disclosure may include a collecting unit 161 and an operating unit 162. The collecting unit 161 may collect conversation information in response to a touch event generated from the touch screen 110. The collecting unit 161 may change the collected conversation information according to change of the conversation mode to collect the changed conversation information. For example, the collecting unit 161 may collect text data input through a key pad window output when the terminal 100 is operated in a text conversation mode.

The collecting unit 161 may activate the camera 140 when the terminal 100 is operated in an image conversation mode to collect user image data, and may collect text data input through the key pad window. In this case, the user image data may include a still image or video data of the user, but not limited thereto.

For example, when the terminal 100 is operated in an image conversation mode, the terminal 100 may collect user image data by capturing a user image through the camera 140 if a text is input through the key pad window according to defined setting or by capturing the user image if a transmission request is detected. Alternatively, when the terminal 100 is operated in the image conversation mode, the terminal 100 may collect user video data by photographing the user through the camera 140 while inputting the text through the key pad window according to the defined setting. In this case, the user video data may include a video image without an audio output sound.

When the terminal 100 is operated in a moving image conversation mode, the collecting unit 161 may activate the camera 140 and the microphone to collect user moving image data. In this case, the user moving image data may include audio data as well as a video image. The collecting unit 161 may extract voice data from the moving image data collected in the moving image conversation mode, and may Speech-To-Text (STT) convert the voice data to collect text data.

The operating unit 162 may execute a conversation function application in response to an execution request event of the conversation function application, and output a screen for supporting an operation of the conversation service function on the display unit 112. The operating unit 162 may control the RF communication unit 120 to transmit at least one of text data, video data, and voice data collected according to the conversation mode to another terminal corresponding to the designated conversational partner. The operating unit 162 may output final conversation information with a selected conversational partner on the display unit 112. When receiving at least one of text data, video data, and voice data from another terminal, the operating unit 162 may change the conversation function screen and output the changed conversation function screen according to the received data. For example, when the text data are received, the operating unit 162 may output a conversation function screen based on a text. When video data or voice data is received together with text data, the operating unit 162 may output the video data on the user designation image region in a thumbnail format, and output information indicating that an image or moving image data of the user is received on the conversation function screen.

Such elements may be variously modified according to the trend of digital convergence, and thus not all such elements may be listed here. However, the terminal 100 according to the present disclosure may further include elements that are not mentioned in the above such as a sensor module to detect information related to variation of a location of the terminal 100, a GPS module to measure the location of the terminal 100, and a camera module. The terminal 100 of the present disclosure may eliminate specific elements from above configuration or may replace specific elements with other configuration in the foregoing arrangements according to the provision type. In addition, an input unit according to the present disclosure may include a touch pad, a track ball, and the like in addition to the touch screen 110 and the key input unit.

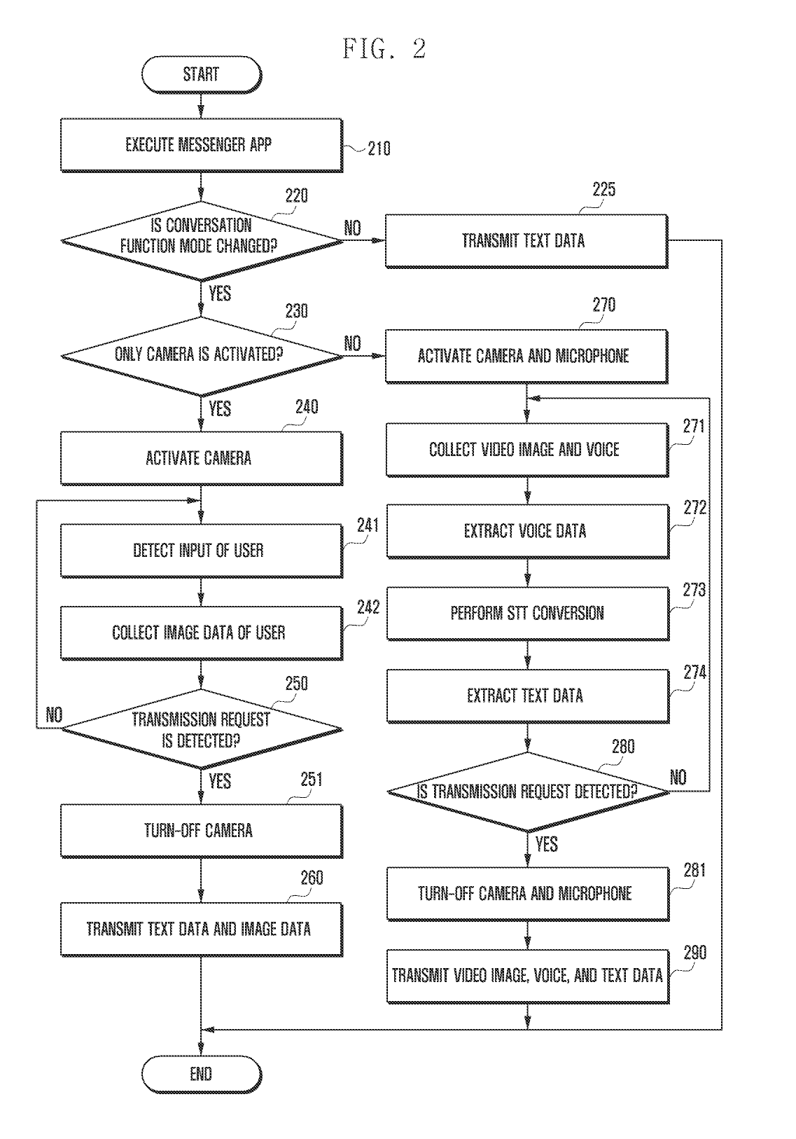

FIG. 2 is a flowchart illustrating a method for operating a conversation service function based on a messenger according to an embodiment of the present disclosure.

Referring to FIG. 2, at operation 210, a terminal 100 may execute a messenger APP to operate a conversation service function according to a user request or a schedule. In this case, the messenger APP may be an APP to support an instant messenger service. The instant messenger service may support a connector information function, for example, a buddy list function to show a list which is currently connected to a messenger server and is able to converse. The buddy list may include unique identification information of respective users and a profile image designated by the users.

At operation 210, the terminal 100 may display a conversation function screen on the display unit 112. In this case, the conversation function screen may include conversation information transmitted and received to and from at least one user participating in a conversation based on a messenger. Basically, conversation information of users may be displayed in the order of input time of the conversation information based on text. Further, the conversation function screen may determine whether a previous conversation record with a user exists. When the previous conversation record exists, the previous conversation record may be output on the conversation function screen.

The conversation function screen may include profile information to identify the other terminal user chatting with the user and a profile image region. An image designated by the terminal user operating the conversation service function based on a messenger may be output to the profile image region, and basically, a defaulted image may be output. Whenever conversation information is received from a conversational partner, the terminal of the present disclosure may output the received image or a thumbnail image corresponding to video data on the profile image region. At operation 220, the terminal 100 may determine whether an input signal for changing a conversation function mode is detected. In the present disclosure, the conversation function mode may include a text conversation mode, an image conversation mode, and a moving image conversation mode. The text conversation mode is defined as a mode based on text, that is, a mode to transmit characters input through a key pad window in an instant method. The image conversation mode is defined as a mode to transmit image data of the user together with a text character in the instant method. The moving image conversation mode is defined as a mode to photograph a moving image of the user to transmit the photographed moving image of the user in the instant method.

The terminal 100 of the present disclosure may output a menu for changing the conversation function mode on the conversation function screen. The conversation function mode change menu may be output as a separate menu region or may be output as a transmission menu region by adding a mode change function. For example, whenever a user input of selecting a mode change menu is detected, a conversation function mode may be sequentially changed to a text conversation mode, an image conversation mode, and a moving image conversation mode.

When an input of the user is not a signal for changing the mode to a multi-mode, at operation 225, the terminal 100 may activate a key pad window to input texts, may collect text data input through the key pad window, and may transmit conversation information based on the collected text data.

At operation 230, the terminal 100 may determine whether only a camera 140 is activated in response to the change of the multi-mode. That is, if the conversation function mode is changed to the image conversation mode, the terminal 100 may activate only the camera 140. On the other hand, if the conversation function mode is changed to the moving image conversation mode, the terminal 100 may activate the camera 140 and a microphone.

If a request of changing to the image conversation mode is detected, at operation 240, the terminal 100 may activate the camera 140. In this case, the camera 140 may be a front camera which is disposed at a front surface of the terminal 100 in order to collect an image of the user, but not limited there to. That is, the camera 140 may be a rear camera which is disposed at a rear surface according to a setting.

At operation 241, the terminal 100 may detect an input of a user to input a text on a message input window of a conversation function screen. For example, if the input selecting the message input window is detected, the terminal 100 may call a key pad window for inputting characters on a specific region of the conversation function screen. The user may input characters for a conversation function through the key pad window. In response to the input, the terminal 100 may detect the input of the characters and may display texts corresponding to the input of the characters on the message input window.

At operation 242, the terminal 100 may collect image data of the user in response to the input of the user inputting characters on the conversation window. In this case, the image data of the user may be a still image or a video image. The still image may be a still image captured through the camera 140 at a time point when the user inputs characters and/or a still image captured through the camera 140 at a time point when a transmission request is detected, but is not limited thereto. The video image may be a video image of the user photographed through the camera 140 from a time when the user inputs the characters on the text input window to a time when the transmission request is detected.

The terminal 100 of the present disclosure may support a function to collect the still image or the video image of the user by activating the camera 140 while the user inputs texts on the conversation function screen in order to operate the conversation function.

At operation 250, the terminal 100 may determine whether a transmission request for the collected data is detected. When the transmission request for the collected data is detected, at operation 251, the terminal 100 may turn-off the camera 140, and transmit text data for the character input displayed on the message input window and image data of the user collected by the camera 140 to a terminal of other user at operation 260.

At operation 270, the terminal 100 may activate the camera 140 and the microphone in response to the conversation mode change request. For example, if the conversation function mode is changed to the moving image conversation mode, the terminal 100 may control the camera 140 and the microphone to be activated. At operation 271, the terminal 100 may collect a video image and a voice of the user through the camera 140 and the microphone. At operation 272, the terminal 100 may extract voice data from a signal provided through the microphone. For example, the terminal 100 may modulate a voice signal received from the microphone to a digital signal by using a CODEC, and extract voice data from the digital signal output from the CODEC. In addition, the terminal 100 may implement various noise removal algorithms to remove a noise generated during a procedure of receiving a voice.

At operation 273, the terminal 100 may perform a STT conversion on the extracted voice data, and extract the converted text data at operation 274. The terminal 100 of the present disclosure may generate voice data by analyzing a characteristic of a voice frequency by a Fast Fourier Transform (FFT) or may generate the voice data by analyzing a characteristic of a voice waveform. Further, the terminal 100 of the present disclosure may convert the voice data into at least one pattern-matched number or letter to generate characters (e.g., text data).

At operation 280, the terminal 100 may determine whether a transmission request for the collected data is detected. When the transmission request for the collected data is detected, at operation 281, the terminal 100 may turn-off the camera 140 and the microphone. At operation 290, the terminal 100 may transmit the user video image and voice data collected through the camera 140 and the microphone and the text data extracted from the voice data to a terminal of other user. When the transmission request for the collected data is not detected, return to operation 270.

As described above, the terminal 100 according to the present disclosure may photograph the image of the user while the user inputs a character (i.e., text) during an operation of a conversation function to transmit the video image and text of the user in an instant method. Further, according to the present disclosure, when the user inputs the voice and the image during the operation of the conversation function, by extracting the text data from the voice data, the terminal may transmit text conversation information of the user similar to the text based conversation function without a separate text input.

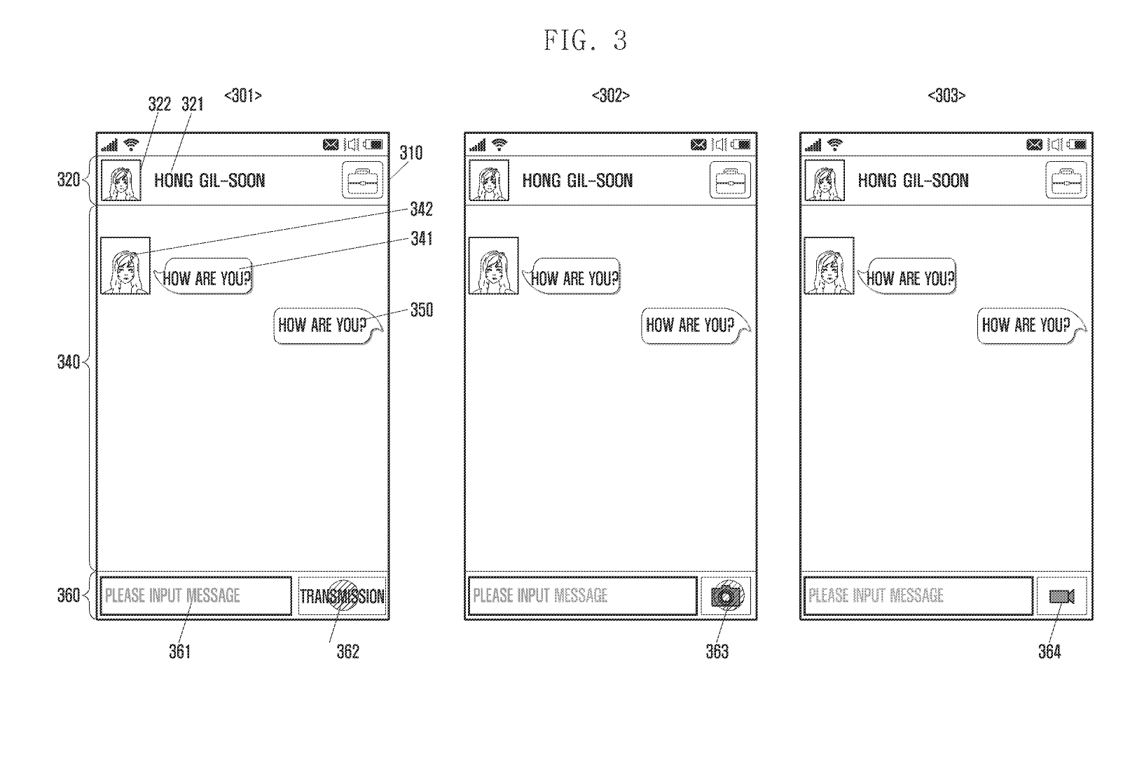

FIG. 3 is a diagram of a user interface screen for illustrating a conversation mode change screen based on a messenger according to an embodiment of the present disclosure.

Referring to FIG. 3, a conversation function screen based on a messenger according to the present disclosure may be configured to output a conversation mode change menu. In this case, the conversation function screen 310 may be a conversation function screen with another user or a plurality of users selected for an operation of the conversation function.

In detail, the conversation function screen 310 may include another user information display region 320, a conversation information display region 340, and a conversation function menu region 360.

The other user information display region 320 may be configured to output other party profile information 321 and a user designation profile image 322. In this case, a default image provided from a messenger application may be output as a user designation profile image. However, when individual users have already set a still image (e.g., photograph), the set still image may be output as a thumbnail image.

The conversation information display region 340 may be configured to output conversation history information with other users in an instant messenger scheme. In this case, the conversation history information may be displayed to include a transmission text message 350 transmitted to another terminal and a reception text message 341 received from another terminal The conversation history information may be displayed in the order of input time of the transmission text message 350 and the reception text message 341, and each text message may be output as a voice bubble and the like. The reception text message 341 and the transmission text message 350 on the conversation function screen may be graphic-processed and displayed to be distinguished by colors, and the like. In addition, the reception text message 341 on the conversation function screen may be configured in such a manner that individual users may output a still image or default image on a profile image region 342 together with other user profile information. The user may visually recognize other user information operating the conversation function through the image and the profile information of other user output on the profile image region 342.

The conversation function menu region 360 may display a message input window 361 and a transmission menu 362. A user interface screen according to the present disclosure may be configured by adding a conversation mode change function to the transmission menu 362. In the embodiment of the present disclosure, it is described the user interface screen is configured by adding the mode change function to the transmission menu 362, but a separate conversation mode change menu may be output on the conversation function screen.

When an input of the user selecting the message input window 361 is detected, the message input window 361 may be configured to output a key pad window for inputting a message. The conversation function menu region 360 may be displayed to include a menu for an operation of the conversation function such as an emoticon menu, an attached file menu, and the like, but is not limited thereto.

For example, when the conversation function screen is output, as illustrated on a screen 301, the transmission menu 362, as default, may be output. In this case, the terminal 100 may be operated in a text conversation mode based on a text. When a message is input to the text input window, the transmission menu 362 may be configured to activate the transmission function.

That is, after a text is input to the message input window 361 through the key pad, the transmission menu 362 may activate the transmission function. If the input of the user inputting the transmission menu 362 is detected after the transmission function is activated, the terminal 100 may control to transmit the text data input to the message input window 361 to other selected terminal in response to the detected input of the user.

In a case of the present disclosure, when the message is not input to the message input window 361, the transmission menu 362 may be used as a conversation mode change function to change a conversation mode. That is, whenever the user input to select the transmission menu 362 is detected before a text is input to the message input window 361, the terminal 100 may sequentially change the mode to the image conversation mode, the moving image conversation mode, and the transmission menu.

For example, as illustrated in screen 301, the user may touch the transmission menu 362 in a state in which the text is not input to the message input window 361. As illustrated in screen 302, the transmission menu 362 on the conversation function screen may output a menu changed to an image conversation mode menu 363.

When the image conversation mode menu 363 is output, the terminal 100 may be operated in the conversation mode based on a text and an image. For example, when the camera 140 is activated and the user inputs characters through the message input window, the terminal 100 may collect image information of the user. In this case, the image information of the user may be the still image or video image data photographed by the camera 140.

In this state, the user may touch again the image conversation mode menu 363. As illustrated in screen 303, the image conversation mode menu on the conversation function screen may be changed to a moving image conversation mode menu 364.

When the moving image conversation mode menu 364 is output, the terminal 100 may be operated in the conversation mode based on text and moving image. For example, the terminal 100 may activate the camera 140 and the microphone to collect moving image information of the user. In this case, the moving image information of the user may be the video data and voice data collected by the camera 140 and the microphone.

Hereinafter, the image conversation mode and the moving image conversation mode will be explained in detail with reference to drawings.

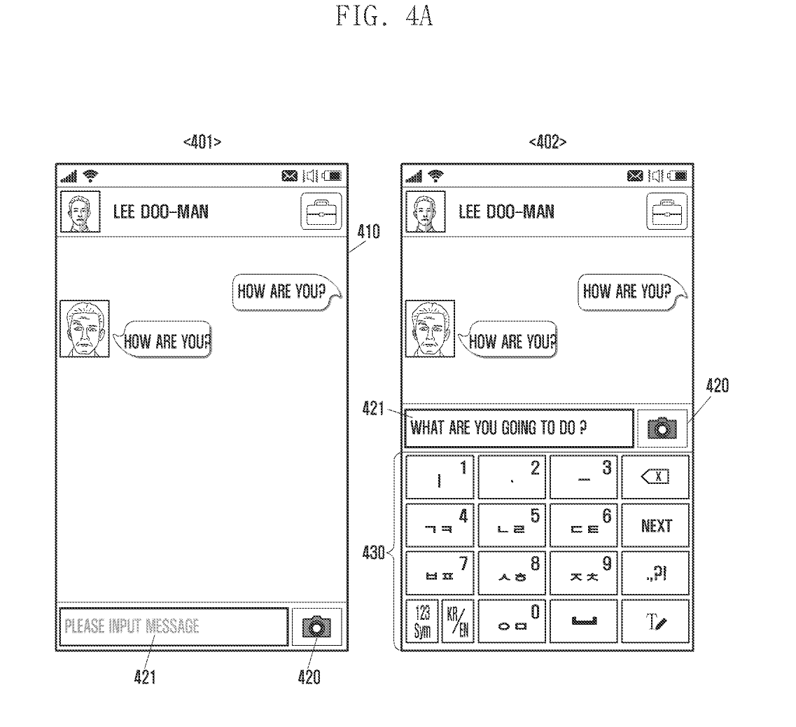

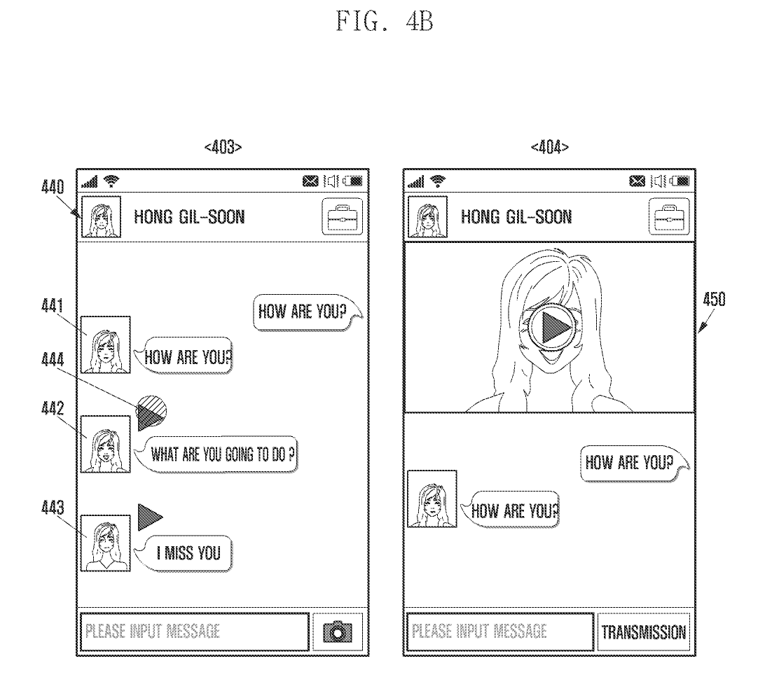

FIGS. 4A and 4B are diagrams of a user interface screen for operating a conversation service function based on a messenger according to an embodiment of the present disclosure.

For the convenience of the description, FIG. 4A illustrates a user interface screen of a transmission terminal, and FIG. 4B illustrates a user interface screen of a reception terminal However, the terminal according to the present disclosure is not limited thereto, but may be a terminal capable of realizing all configurations of the present disclosure.

Referring to FIG. 4A, according to a user request, the transmission terminal may output an image conversation mode menu 420 on the conversation function screen 410 as illustrated in a screen 401. That is, the transmission terminal may activate the camera 140 in response to a change event to the image conversation mode.

In this state, the user may touch a message input window 421. In response to this, the transmission terminal may output a key pad window 430 on the conversation function screen 410 as illustrated on a screen 402. The user may input a conversation, that is, a text message through the key pad window.

If a text input is detected through the key pad window 430, the transmission terminal photographs the image of the user through the camera 140. In this case, the transmission terminal may capture the image of the user through the camera 140 to collect still image data, or to collect video image data while the image is input.

When it is detected that a text is input to the message input window 421 through the key pad window 430, the transmission terminal may activate a transmission function. In this case, the image conversation mode menu 420 may be changed to the transmission menu, but is not limited thereto.

After the user completes a text input through the key pad window 430, the user may touch the image conversation mode menu 420 or the transmission menu. Accordingly, the transmission terminal may transmit the collected conversation information, that is, the text data input to the message input window 421 and the user image information collected by the camera 140 to the reception terminal

A conversation function screen of the reception terminal responding to the above mentioned operation is as follows.

Referring to a screen 403 of FIG. 4B, a conversation function screen 440 of the reception terminal may be configured to output a reception text message received from the transmission terminal, and to output a thumbnail image corresponding to user image data received on the profile image region.

For example, as illustrated screen 403, firstly, when only text data is transmitted from the transmission terminal, the conversation function screen 440 of the reception terminal may output a profile image 441 previously set in the transmission terminal on the profile image region, and may display a first message (e.g., how are you) corresponding to the text data. In response to this, when the reception terminal transmits a response message, the conversation function screen may be configured to output the conversation information in an instant method.

Next, secondly, when receiving conversation information including a text and video image data from the transmission terminal, the conversation function screen 440 may output a first thumbnail image 442 corresponding to video data to the profile image region, and may display a second image (e.g., what are you going to do?) corresponding to the text data. In this case, when the user image data is a still image, an image output on the user profile image region may be differently displayed according to received image data whenever the message is received.

Next, when the conversation information including the text and the video image data is received from the transmission terminal, the conversation function screen may output a second thumbnail image 443 corresponding to the video data on the profile image region, and may display a third message (e.g., I miss you) corresponding to the text data.

Further, when the user image data is the video image data, the conversation function screen 440 of the reception terminal may output an icon 444 or information (e.g., a play icon) indicating that the user profile image is the video data, but the present disclosure is not limited thereto.

In this state, the user may recognize that the user profile image is changed and select a thumbnail image output on the user profile image.

The transmission terminal may detect that the thumbnail image is selected, and may divide the conversation function screen into a conversation information display screen and a play screen 450 of the video data on screen 404. In this case, the play screen of the video data may be output by dividing a screen region or by being overlapped with a part of the conversation function screen.

Further, when the received user image data is a still image, if an input of the user selecting the still image output on the profile image region is detected, the transmission terminal may extend the output still image to separately display the extended still image from the conversation information indication region.

As described above, according to the embodiment of the present disclosure, users operating a conversation service function based on a messenger may photograph an image of the user or a surrounding environment image whenever transmitting the message, and transmit the user image or the surrounding environment image together with the text image in an instant method. Accordingly, the user receiving the conversation message may simultaneously view the conversation function screen and a video screen in real time through the user image or the surrounding environment image which is changed whenever a conversation message is received without a change of an application.

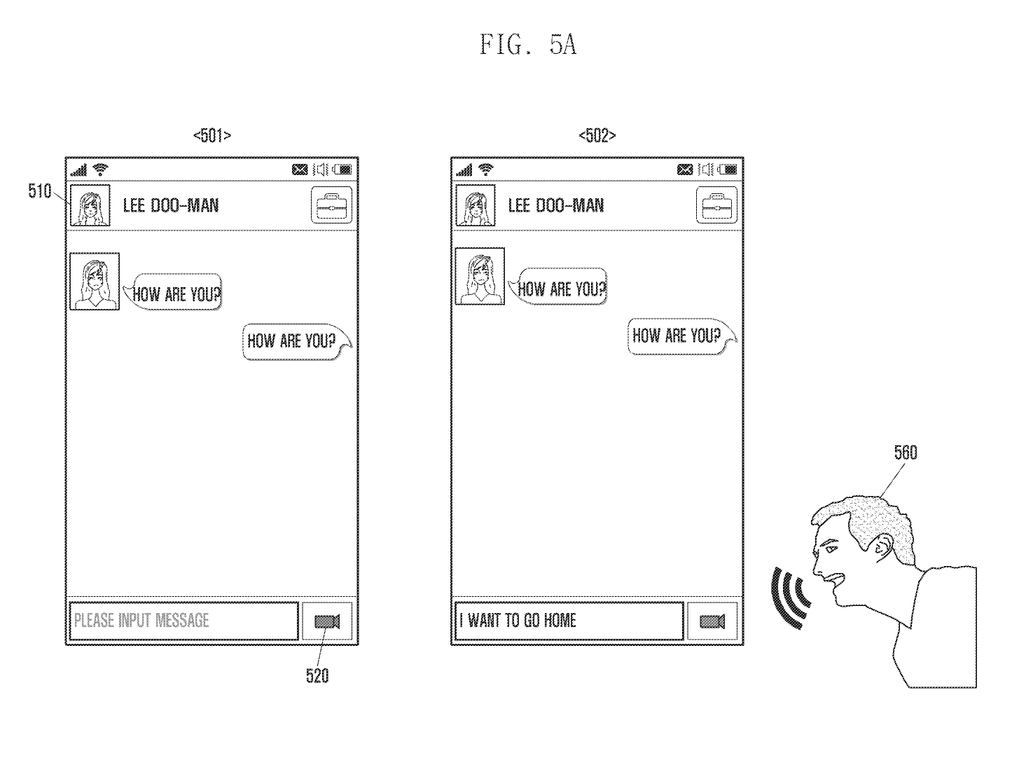

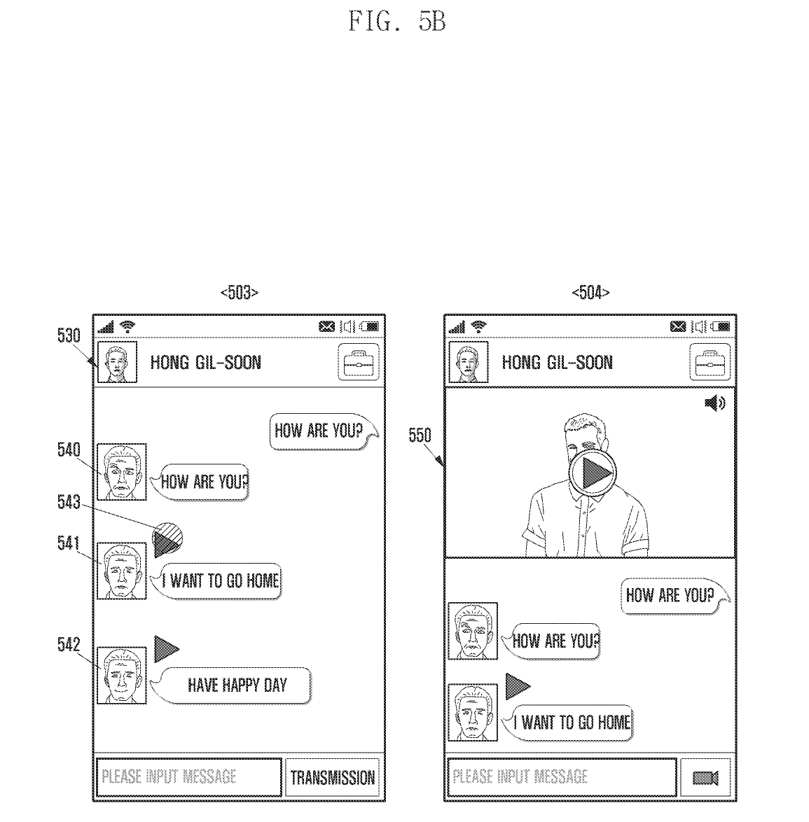

FIGS. 5A and 5B are diagrams of a user interface screen for operating a conversation service function based on a messenger according to an embodiment of the present disclosure. In this case, for the convenience of the description, FIG. 5A illustrates a user interface screen of the transmission terminal, and FIG. 5B illustrates a user interface screen of the reception terminal.

Referring to FIG. 5A, if a change event to a moving image conversation mode is detected during an operation of a conversation service function, as illustrated on a screen 501, the transmission terminal may output a moving image conversation mode menu 520 indicating the operation of a moving image conversation mode on a conversation function screen 510. The transmission terminal may activate the camera 140 and the microphone in response to the change event to the moving image conversation mode, and photograph the user image and the voice signal through the camera 140 and the microphone. As illustrated in a screen 502, the conversation function screen 510 in a moving image conversation mode may be configured not to output a key pad window as in the image conversation mode.

When the collection of the user image and the voice signal is detected, the terminal 100 may change the moving image conversation mode menu 520 to a transmission menu or activate a transmission function.

When the user image and the voice signal are detected in the moving image conversation mode, the terminal 100 extracts voice data, and perform a SST conversion on the extracted voice data to extract text data. For example, the user may change the terminal 100 to be operated in the moving image conversation mode in a state in which the conversation function screen is output, and may input a voice of “I want to go home”. Accordingly, the transmission terminal may collect a voice signal of “I want to go home” and a video image of the user while a voice is input 560, and may analyze the voice signal to extract text data of “I want to go home”. If a transmission request is detected, the transmission terminal may transmit the collected text data, and the video data and voice data of the user to the reception terminal.

Referring to FIG. 5B, in response to the transmission, a conversation function screen 530 of the reception terminal may be configured to output moving image data received on the profile image region together with a reception text message received from the transmission terminal Since the conversation function screen 530 has the same arrangement as that of FIG. 4B, a detailed description thereof is omitted. That is, as shown in FIG. 5A, when moving image data is received in an instant method from other user through a messenger application, the conversation function screen 530 of the reception terminal may output received moving image data on the profile image region in a thumbnail format.

For example, as illustrated in a screen 503, the reception terminal may sequentially receive a first message, a second message, and a third message from the transmission terminal in the order of time. In this case, the first message (e.g., How are you) may correspond to a case of receiving text data based on a text, and the second message (e.g., I want to go home) and the third message (e.g., Have a happy day) may correspond to a case of receiving text data and moving image data. A text message corresponding to text data is displayed on the first message, and a profile image 540 designated in the transmission terminal is displayed on the profile image region.

In contrast, in a case of the second message and the third message, thumbnail images 541 and 542 corresponding to moving image data received together with reception of a message are displayed on a profile image region. That is, a thumbnail image output on a profile image region is changed corresponding to moving image data changed each time the message is received and an icon 543 indicating that moving image data are received may be output.

In this state, if a playing request for moving image data received on the profile image region is detected, as illustrated in screen 504, the reception terminal may display a screen 550 playing a moving image of user (e.g., an image and a voice) transmitted a conversation message on a partial region of a conversation function screen.

According to the method for operating a conversation service function based on a messenger, an user interface, and a user device supporting the same of the present disclosure, a user image is collected together with input of a conversation character automatically or based on control of the user according to a condition, and the collected user image may be transmitted to a terminal of other user together with the conversation character in the instant method. Further, the present disclosure may support to output the user image collected on a user designation image region of the character conversation function screen in a thumbnail format, and may easily play and output the user image at a time of the input of the character when the play of the user image is requested.

In addition, the conversation information is intuitively and efficiently displayed to improve the function of the conversation service by extracting the text data from the voice to provide the text data and the user video data in the instant method, when a voice of the user is detected during the operation of the conversation service function.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating a conversation service function based on a messenger, the method comprising:
detecting an input of a user requesting a change of a conversation mode during an operation of the conversation service function;
activating a camera according to the change of the conversation mode;
collecting user image data from the activated camera; and
transmitting the collected user image data and a text message generated according to the input of the user to a terminal.

2. The method of claim 1, wherein the collecting of the user image data comprises collecting at least one of sill image data, video image data, and voice data.

3. The method of claim 2, wherein the collecting of the still image data comprises collecting still image data of the user collected by the camera at one of a time point of detecting the input of user inputting the text message and a time point of detecting an input of a request for conversation transmission.

4. The method of claim 1, wherein the collecting of the video image data comprises collecting video image data of the user collected by the camera while the text message is input.

5. The method of claim 2, further comprising:
performing a Speech-To-Text (STT) conversion on the voice data to extract text data when the video image data and the voice data are collected,
wherein the transmitting of the collected user image data comprises transmitting the extracted text data, the collected video image data, and the collected voice data to the terminal.

6. A method for operating a conversation service function based on a messenger, the method comprising:
receiving conversation information comprising at least one of text data, still image data, video image data, and voice data during an operation of the conversation service function; and
displaying a conversation function screen to output a text message based on the received conversation information and to output a thumbnail image corresponding to one of the received still image data and the received video image data on a user designation profile image region.

7. The method of claim 6, wherein the displaying of the conversation function screen comprises outputting one of an icon and information indicating that the video image data is received when the video image data is received.

8. The method of claim 6, further comprising:
detecting a user input to select the thumbnail image output on the user designation profile image region; and
dividing a screen into an output screen of one of the still image data and the video image data corresponding to the thumbnail image and the conversation function screen in response to the user input.

9. A terminal for supporting a conversation service function based on a messenger, the terminal comprising:
a radio frequency communication unit configured to support transmission and reception of conversation information comprising at least one of text data, still image data, video image data, and voice data during an operation of a conversation function based on the messenger;
a display unit configured to display a conversation function screen according to an operation of the conversation function based on the messenger; and
a controller configured to output a text message based on the conversation information, and to output a thumbnail image corresponding to one of the received still image data and the received video image data on a user designation profile image region, when the still image data and the video image data are received during the operation of the conversation function based on the messenger.

10. The terminal of claim 9, wherein the controller is further configured to detect an input of a user requesting change of a conversation mode during the operation of the conversation function, activate a camera according to the change of the conversation mode, collect user image data from the activated camera, and transmit the collected user image data and a text message generated according to the input of the user to a terminal.

11. The terminal of claim 9, wherein the controller is further configured to collect at least one of sill image data, video image data, and voice data.

12. The terminal of claim 11, wherein the controller is further configured to one of collect the still image data of the user collected by the camera at one of a time point of detecting the input of user inputting the text message and a time point of detecting an input of a request for conversation transmission, and collect the video image data of the user collected by the camera while the text message is input.

13. The terminal of claim 11, wherein the controller performs a STT conversion on the voice data to extract text data when the video image data and the voice data are collected, and transmits the extracted text data, the collected video image data, and the collected voice data to the terminal.

14. The terminal of claim 9, wherein the display unit displays one of an icon and information indicating that the video image data is received when the video image data is received.

15. The terminal of claim 9, wherein the display unit divides a screen into an output screen of one of the still image data and the video image data corresponding to the thumbnail image and the conversation function screen, when a user input selecting the thumbnail image output on the user designation profile image region is detected.

16. At least one non-transitory processor readable medium for storing a computer program of instructions configured to be readable by at least one processor for instructing the at least one processor to execute a computer process for performing the method as recited in claim 1.

17. At least one non-transitory processor readable medium for storing a computer program of instructions configured to be readable by at least one processor for instructing the at least one processor to execute a computer process for performing the method as recited in claim 6.
